(19) United States
(12) Patent Application Publication
(10) Pub. No.: US 2017/0160800 A1
(43) Pub. Date: Jun. 8, 2017

(54) DEVICE CONTROL

(71) Applicant: Nokia Technologies Oy, Espoo (FI)

(72) Inventors: Jukka REUNAMAKI, Tampere (FI); Arto PALIN, Akaa (FI); Juha SALOKANNEL, TAMPERE (FI); Riitta VÄÄNÄNEN, Helsinki (FI); Sampo VESA, Helsinki (FI); Miikka VILERMO, Siuro (FI); Matti HÄMÄLÄINEN, Lempäälä (FI)

(73) Assignee: Nokia Technologies OY, Espoo (FI)

(21) Appl. No.: 15/321,634

(22) PCT Filed: Jul. 9, 2014
(86) PCT No.: PCT/FI2014/050567

§ 371 Date: Dec. 22, 2016

(51) Int. Cl. G06F 3/01; G06F 3/0346

(52) U.S. Cl. CPC G06F 3/013; G06F 3/0346; G06F 3/012; H04B 7/24

(57) ABSTRACT

Devices such a printer 4, television 3 and car door lock 2 are controlled wirelessly by a controller 5 which may consist of eye tracking glasses that detect the gaze angle of the user also include an orientation detector that receives rf packets from the devices, from which the orientation of the device can be detected. Control of the devices is performed wirelessly when the detected orientation of the device and the gaze detection angle adopt a predetermined relationship, for example when they become aligned.

### FIELD

This specification relates generally to controlling a device wirelessly.

### BACKGROUND

Various systems are known for remotely controlling electronic devices. These include the transmission of infra-red or radio frequency signals, voice, or other audio, control and even motion detection.

### SUMMARY

In one embodiment, a method comprises: determining a direction of gaze of a user; determining an orientation of a first device with respect to a second device based on at least one radio frequency packet passed wirelessly between the first and second devices using an array of antennas forming part of one of the devices; and determining if the direction of gaze and the orientation of the first device with respect to the second device adopt a predetermined relationship, for controlling a given operation.

The given operation may comprise an operation of the first device, and control signals may be sent for controlling the first device for performance of the given operation upon determination that the direction of gaze and the orientation of the first device with respect to the second device have adopted the predetermined relationship.

The predetermined relationship between the direction of gaze and the orientation of the first device with respect to the second device may include when the direction of gaze and the orientation of the first device with respect to the second device are in alignment, although other relationships may be used.

The determining of whether the direction of gaze and the orientation of the first device with respect to the second device adopt a predetermined relationship may be performed by means of a processor that may be included in the second device.

A gaze direction detector such as a retina movement detector in eye tracking glasses may be used to determine the direction of gaze of a user, which may comprise the second device.

An orientation detector located in the second device may be used to determine the orientation of the first device with respect to the second device.

Control signals for controlling operation of the first device may be transmitted in response to determining that the direction of gaze detected by the gaze detection detector and the orientation of the first device with respect to the second device determined by the orientation detector, have adopted said predetermined relationship, for example are in alignment.

The method may include detecting a predetermined gesture made by a user, for causing control signals to be transmitted for the first device.

The second device may include said array of antennas to receive at least one radio frequency to packet passed wirelessly thereto from the first device, and the method may include comparing signals received by the antennas of the array in response to said at least one radio frequency packet to determine the orientation of the first device with respect to the second device.

An embodiment of apparatus described herein comprises: at least one processor to receive gaze direction signals corresponding to a direction of gaze of a user, from a gaze direction detector; and orientation signals from an orientation detector operable to determine, based on at least one radio frequency packet passed wirelessly between first and second devices using an array of antennas forming part of one of the devices, an orientation of the first device with respect to the second device; the processor being operable in response to the gaze direction signals and the orientation signals, to determine if the direction of gaze detected by the gaze detection detector and the orientation of the first device with respect to the second device determined by the orientation detector adopt a given relationship, for controlling operation of the first device.

The processor may be included in the second device, which may also include the gaze direction detector. The second device may comprise eye tracking glasses including a detector for detecting retina movement, which may also include the orientation detector.

A transmitter may be provided coupled to the processor to transmit control signals for use in controlling the first device in response to the processor determining that the direction of gaze detected by the gaze detection detector and the orientation of the first device with respect to the second device determined by the orientation detector have adopted said given relationship, such as alignment thereof.

Also, the processor is responsive to the gaze direction signals and/or the orientation signals to detect a predetermined gesture made by a user, for causing the transmitter to transmit control signals for the first device.

The second device may include the array of antennas to receive at least one radio frequency packet passed wirelessly thereto from the first device, and a comparator to compare signals received by the antennas of the array in response to said at least one radio frequency packet to determine the orientation of the first device with respect to the second device.

An embodiment may include least one non-transitory computer readable memory medium having computer readable code stored therein, the computer readable code being configured to cause a processor to: determine a direction of gaze of a user; determine, based on at least one radio frequency packet passed wirelessly between first and second devices using an array of antennas forming part of one of the devices, an orientation of the first device with respect to the second device; and determine if the direction of gaze and the orientation of the first device with respect to the second device adopt a predetermined relationship, for controlling operation of the first device.

Also, an embodiment may include apparatus, comprising: means for receiving receive gaze direction signals corresponding to a direction of gaze of a user, from a gaze direction detector; means for receiving orientation signals from an orientation detector operable to determine, based on at least one radio frequency packet passed wirelessly between first and second devices using an array of antennas forming part of one of the devices, an orientation of the first device with respect to the second device; and means responsive to the gaze direction signals and the orientation signals, for determining if the direction of gaze detected by the gaze detection detector and the orientation of the first device with respect to the second device determined by the orientation detector adopt a given relationship, for controlling operation of the first device.

### BRIEF DESCRIPTION OF THE DRAWINGS

For a more complete understanding of example embodiments of the present invention, reference is now made to the following description taken in connection with the accompanying drawings in which:

FIG. 1 is a schematic diagram of a wireless control system in which remote devices are controlled wirelessly by use of a controller;

FIG. 2 is a schematic illustration of a controller including eye tracking glasses for use in the system of FIG. 1;

FIG. 3 is a block diagram of the major components of the controller;

FIG. 4 is a diagrammatic illustration of a positioning signal;

FIG. 5 is a block diagram of a remotely controlled device;

FIG. 6 is a schematic block diagram of a mobile device;

FIG. 7 is a flow chart of controlling operation of a printer;

FIG. 8 is a flow chart of controlling operation of a television;

FIG. 9 is a schematic illustration of controlling operation of a car door lock; and

FIG. 10 is a flow chart of controlling operation of the car door lock.

### DETAILED DESCRIPTION OF EXAMPLE EMBODIMENTS

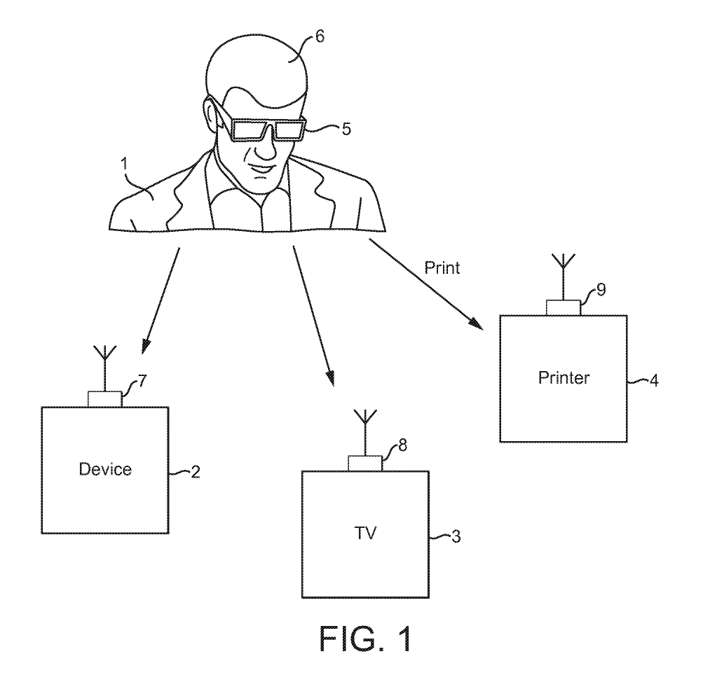

Referring to FIG. 1, a remote control system is illustrated which permits a user 1 to interact wirelessly with remote devices 2, 3, 4 through the use of a remote controller 5, which in this example is conveniently embodied in a pair of glasses worn on the head 6 of the user 1. Each of the remote devices is provided with a radio frequency tag 7, 8, 9 which transmits an identity signal from which the orientation of the device with respect to the controller 5 can be determined, as described in more detail hereinafter. Additionally, the controller 5 includes a gaze detector which may utilise a retina detector to determine the angle of gaze of the user, for example as provided in eye tracking glasses.

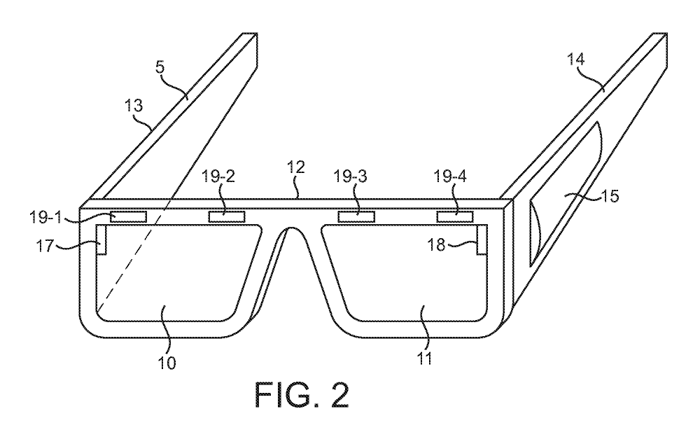

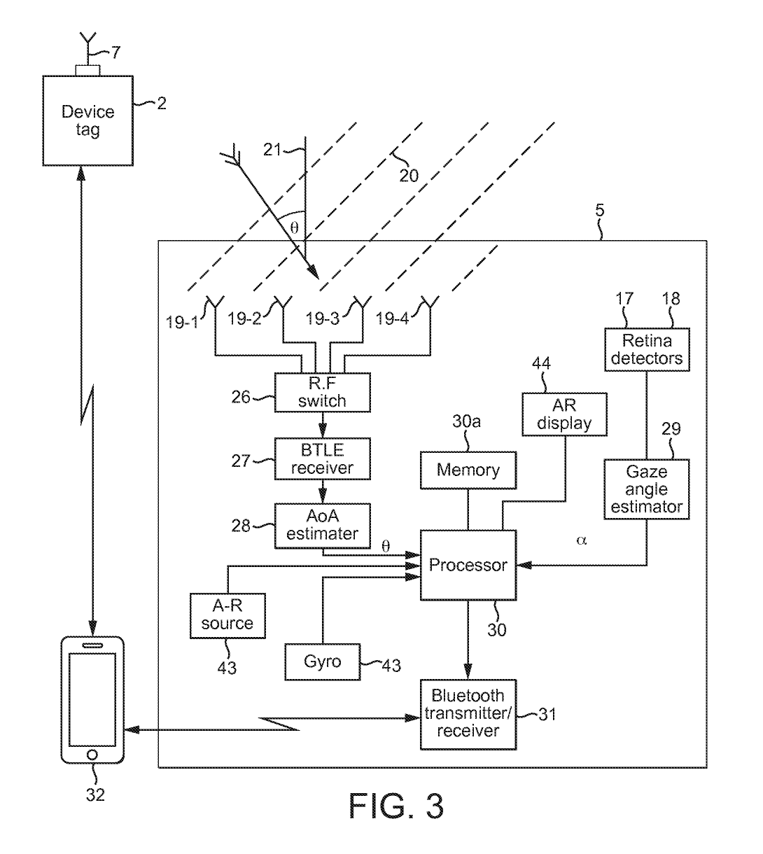

Referring to FIGS. 2 and 3, the controller 5 comprises glasses with lenses 10, 11 received in a frame 12 with foldable side arms 13, 14 that include a chamber 15 which receives the electronic circuits illustrated in FIG. 3 and a battery (not shown).

The eye tracking glasses 5 include retina detectors 17, 18 which detect the user's eye movement. Also, the frame 12 of the glasses includes an array of antennas 19-1, 19-2, 19-3, 19-4 that detect signals transmitted by the device tags 7, 8, 9. The tag 7 is illustrated schematically by way of example in FIG. 3 and the controller 5 is shown receiving signals from the tag 7 to determine its orientation with respect to the controller 5. The antennas 19-1, 19-2, 19-3, 19-4 act as a phased array which can detect the angle of incidence of signals from the tag 7. The signals are shown to have wave fronts travelling in the direction of dotted lines 20 at an angle of incidence θ to the normal 21 of the antenna array 19.

The tag 7 may be configured to operate using any suitable type of wireless transmission/reception technology. Suitable types of technology include, but are not limited to Bluetooth Basic Rate/Enhanced Data Rate (BR/EDR) and Bluetooth Low Energy (BTLE). Bluetooth Low Energy (BLE) is a new wireless communication technology published by the Bluetooth SIG as a component of Bluetooth Core Specification Version 4.0. BLE is a lower power, lower complexity, and lower cost wireless communication protocol, designed for applications requiring lower data rates and shorter duty cycles. Inheriting the protocol stack and star topology of classical Bluetooth, BLE redefines the physical layer specification, and involves many new features such as a very-low power idle mode, a simple device discovery, and short data packets. Other types of suitable technology include WLAN and ZigB. The use of BTLE may be particularly useful due to its relatively low energy consumption and because most mobile phones and other portable electronic devices will be capable of communicating using BTLE technology.

The signals transmitted by the device tag 7 may be according to the Nokia High Accuracy Indoor Positioning (HAIP) solution for example as described at http://www.in-location-alliance.com.

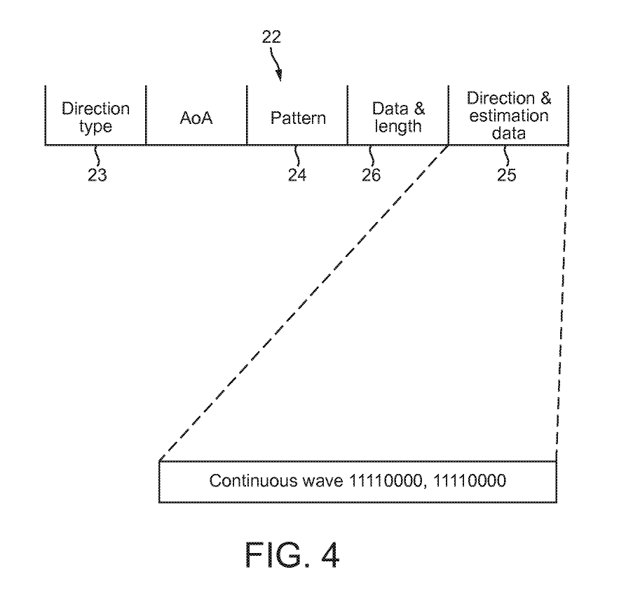

FIG. 4 illustrates an example of a positioning packet 22 which may be transmitted from tag 7 for device 2. The positioning packet 22 may include an indication (or field) 23 of the type of positioning packet 22, so as indicate whether the packet relates to an angle-of-arrival (AoA) information, angle-of-departure (AoD) information or both. In this example, an AoA packet is used, which is received by the antenna array 19 and used to compute the bearing angle θ for the tag 7 relative to the antenna array 19. However, it will be understood that in some examples AoD positioning packets may be used instead of or in addition to AoA packets.

The positioning packet 22 may also include a reference binary bit pattern field 24 which indicates a repeating bit pattern which, in this example is “11110000” that is transmitted in a direction estimation data field 25. The positioning packet 22 may also include a data and length field 26 that includes data such as coding, length of the direction estimation field 25 together with other factors useful in enabling the controller 5 to determine the orientation of the tag 7. It will be understood that the pattern 24 of the signal can be used as an identity signal to individually identify each tag such as tag 7.

Referring again to FIG. 3, a RF switch 26 sequentially connects the individual antennas 19-1, 19-2, 19-3, 19-4 to a receiver 27, in this example a BTLE receiver which provides sequential signals from the individual antennas to an AoA estimator 28 in order to determine the angle θ corresponding to the orientation of tag 7 relative to the antenna array 19, which in turn corresponds to the orientation of the head 6 of the user 1 wearing the glasses that comprise the controller 5.

Also, referring to FIG. 3, the retina detectors 17, 18 provide signals to a gaze angle estimator 29. The retina detectors may operate using photodetectors which track movement of the user's retina so as to determine their gaze direction α.

Signals corresponding to the angle θ computed by the AoA estimator 28 together with gaze angle signals computed by the estimator 27 are fed to a processor 30 which has an associated memory 30a that stores computer program instructions for operating the device, including comparing the gaze angle α of the user with the angle of orientation θ for the device tag 7. The computer program instructions may provide the logic and routines that enable the device to perform the functionality described herein. The computer program instructions may be pre-programmed or they may arrive at the device via an electromagnetic carrier signal or be copied from a physical entity such as a computer program product, a non-volatile electronic memory device (e.g. flash memory) or a record medium such as a CD-ROM or DVD. They may for instance be downloaded to the device from a server.

The processor 30 may be configured to determine when the detected angle of orientation θ adopts a predetermined relationship with the gaze angle α, and in response provide control signal to allow one of the devices 2, 3, 4 to be controlled by the user.

In the example shown in FIG. 3, the processor 30 provides an output to rf transmitter 31, conveniently a Bluetooth transmitter such as a BLE transmitter/receiver, which can be used for controlling remote devices wirelessly. Typically, the BLE transmitter receiver 31 comprises a processor coupled connected to both volatile memory and non-volatile memory. A computer program is stored in the non-volatile memory and is executed by the processor using the volatile memory for temporary storage of data or data and instructions.

The wireless control can be carried out directly with individual devices as illustrated schematically in FIG. 1 or through the intermediary of a further device such as a mobile phone 32 illustrated in FIG. 3 as will be explained in more detail hereinafter.

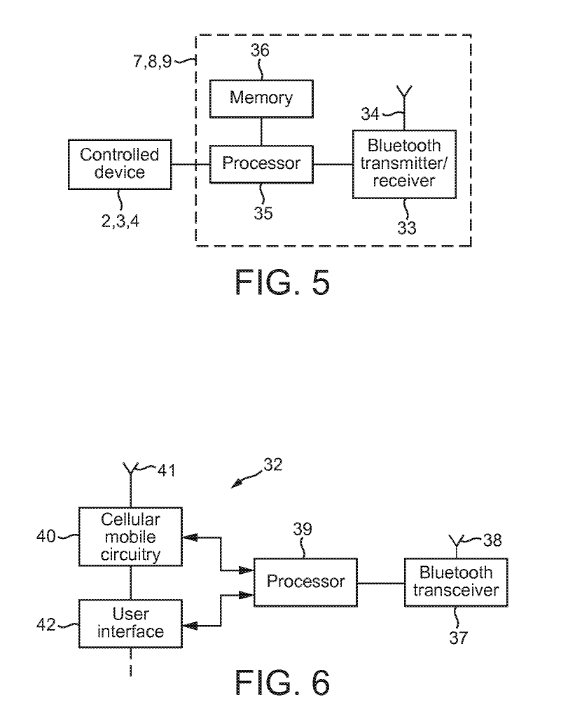

Each of the devices 2, 3, 4 shown in FIG. 1 has control circuitry as illustrated in FIG. 5. The device 2, 3, 4 has a wireless transmitter receiver 33 with an associated antenna 34, together with a processor 35 and memory 36 which perform the function of the tags 7, 8, 9 shown in FIG. 1. The processor 35 in association with memory 36, produces the AoA signal 22 shown in FIG. 4 with a distinctive pattern 24 corresponding to the identity of the individual device 2, 3, 4. The transmitter/receiver 33 transmits the AoA signal and can also receive command signals from the Bluetooth transmitter 31 or another control device such as mobile phone 32.

A schematic block diagram of major circuit components of mobile phone 32 is illustrated in FIG. 6. The phone 32 includes a Bluetooth transmitter/receiver 37 with an associated antenna 38 coupled to a processor 39 which receives Bluetooth commands from Bluetooth transmitter 31 of controller 5 and is also capable of transmitting Bluetooth wireless commands, for example to device 2 and its associated tag 7. The mobile phone 32 includes cellular mobile circuitry 40 with an associated antenna 41 for use with a mobile telephony network, together with a user interface 42, for example a touch screen.

The controller 5 may be used to control the individual devices 2, 3, 4 directly over a Bluetooth link by transmitting command signals from Bluetooth transmitter 31 directly to the tags, or through the intermediary of the mobile phone 32. Various examples will now be described by way of illustration.

Considering the printer device 4 shown in FIG. 1, print commands such as “start printing” and “stop printing” may be wirelessly transmitted to the printer 4 via tag 9 from the

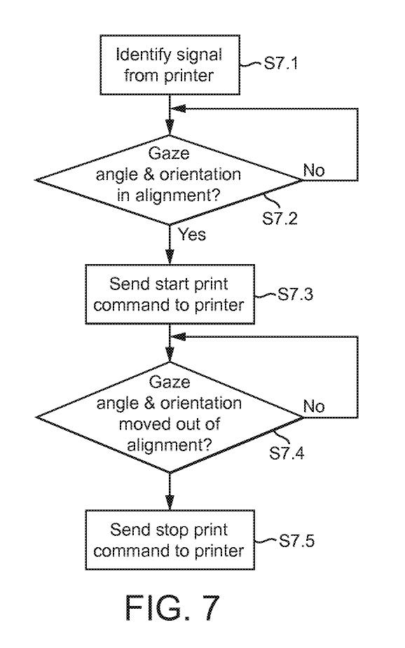

Bluetooth transceiver 31 of the controller 5. The process is illustrated schematically in FIG. 7.

At step S7.1 the AoA signal from tag 9 is detected at the antenna array 19 of controller 5 and the angle θ of orientation is computed by the AoA estimator 28 as previously described.

Also, the retina detectors 17, 18 provide signals to gaze angle estimator 29, which computes the gaze angle α.

Processor 30 determines at step S7.2 whether the gaze angle α and orientation θ are in alignment i.e. whether the user 1 is both gazing at the printer and has his/her head pointing at the printer. The alignment of the gaze angle α and orientation θ is deemed to indicate that the printer 4 should be instructed to start printing and in response, the processor 30 sends a command signal to Bluetooth transmitter/receiver 31 which is communicated wirelessly over a Bluetooth link to the printer tag 9 to be received by the Bluetooth transmitter/receiver 33 and processor 35, which in turn commands the printer 4 to start printing, as shown at step S7.3.

Movement of the user's gaze away from the printer can be used as a command to stop the printer 4. As indicated at step S7.4, when the processor 30 detects that the gaze angle α and orientation θ move out of alignment, a stop print command is sent to Bluetooth transmitter 31, to be received by receiver 33, so that the processor 35 commands the printer to stop printing, as illustrated at step S7.5.

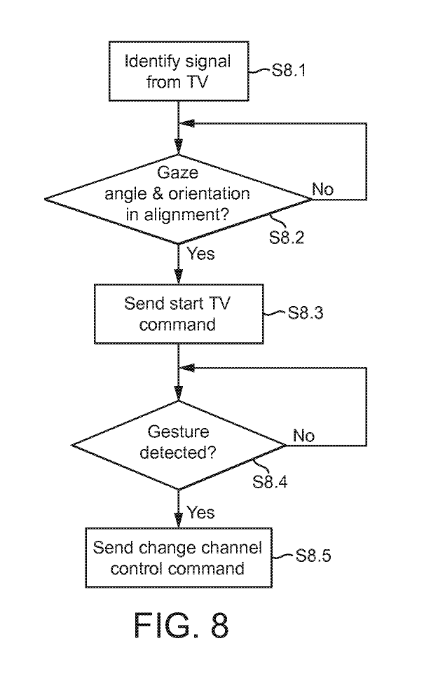

In another example, the TV 3 shown in FIG. 1 can be controlled using the controller 5, according to a process illustrated in FIG. 8. At step S8.1, the signal 22 shown in FIG. 4 from the tag 8 associated with the TV 3 is detected and identified by processor 30, as illustrated at step S8.1.

At step S8.2, processor 30 determines whether the detected orientation θ is aligned with the gaze angle α computed by the gaze angle estimator 29. If so, the processor sends a start TV is command to Bluetooth transmitter/receiver 31, which is wirelessly transmitted to tag 8 at step S8.3. This is received by the Bluetooth transmitter/receiver 33 of tag 8 and in response, the processor 35 commands the TV 3 to switch on.

Also, the user of controller 5 may use gestures such as head movement or gaze angle movement to perform additional commands for the TV 3 such as changing channel, increasing or decreasing volume and switching off. At step S8.4, the processor 30 detects a predetermined transitory change in relationship between the gaze angle α and orientation θ so as to detect the gesture. Additionally, the controller 5 may include a solid state gyro device 43 which may provide additional orientation signals to the processor 30 to assist in identifying the occurrence of a gesture.

When a gesture is detected at step S8.4, a further command is sent by processor 30 to the Bluetooth transmitter 31 to be received by receiver 33, so that the processor 35 can instruct the device 3 to carry out the additional command such as changing channel/volume/switching off, as illustrated at step S8.5.

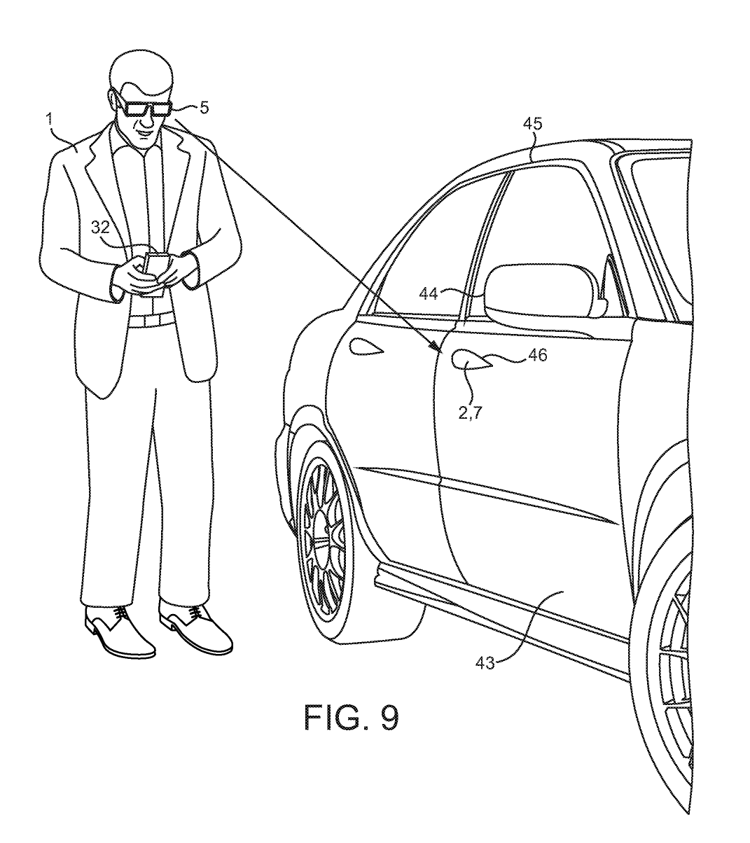

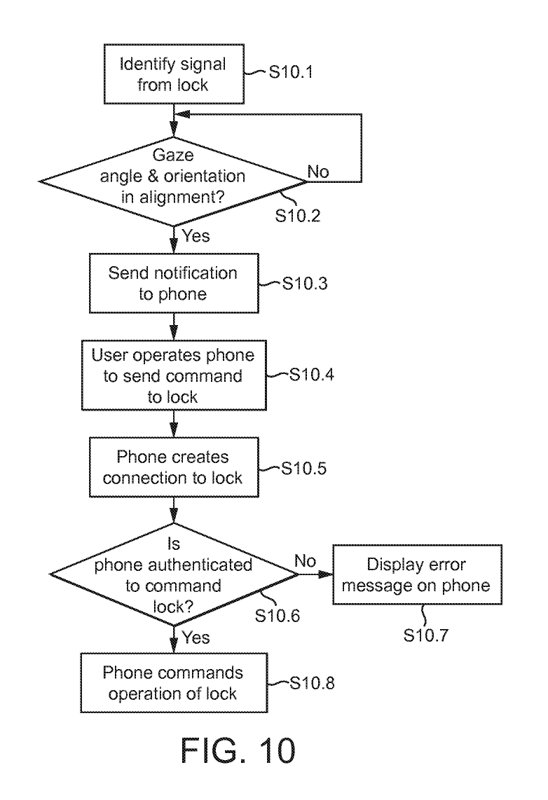

In the foregoing examples, commands are wirelessly transmitted directly over a wireless link such as BTLE from the controller 5 to the controlled device. However, the commands may be transmitted through the intermediary of another device such as the mobile phone 32. For example, the controller 5 may cooperate with the mobile phone 32 to open and close a door lock 2 with a tag 7, such as a car or automobile door lock as illustrated in FIG. 9, according to a process illustrated in FIG. 10.

The tag 7 may be positioned on the car so that the BTLE signals transmitted to and from the transmitter/receiver 33 are not screened significantly by the generally metallic body 43 of the car. For example, the tag 7 may be mounted in the side mirror 44 in or on the window frame 45 or in the door handle 46 of the car. Alternatively, the tag 7 may be situated inside the car further away from the lock 2, in which case the transmission power of the transmitter/receiver 33 is configured to be sufficiently high that the attenuation caused by the metal shield of the car does not degrade remote wireless operation of the lock. If the tag 7 is situated significantly away from the lock, the direction detection process performed by to processor 30 should take into account that the applicable angle towards the lock may be relatively wide when the user is close to the car than when the user is more distant from it.

At step S10.1, signal 22 from lock 2 is detected by the controller 5. When the user 1 wishes to open the car door lock 2, he/she gazes at the door lock so that at step S10.2, the processor 30 detects that the orientation angle θ computed from the AoA signal from device tag 7, is in alignment with the gaze angle α. In response, at step S10.3 the processor 30 sends a command signal to Bluetooth transmitter/receiver 31, addressed to the Bluetooth transceiver 37 of mobile phone 32. The processor 39 of the mobile phone then provides to the user interface 42 an indication for user 1 that the lock is in a condition to be opened, and provides the user an opportunity to command the lock to be opened.

As illustrated at step S10.4, the user operates the user interface of phone 32, which sends an instruction to processor 39 that, in turn transmits a Bluetooth signal from transmitter 37 to the tag 7, commanding the door lock to be opened.

In a preparation step, not shown in FIG. 10, the transceiver 37 of the phone 32 is paired with the car lock transmitter/receiver 33 and the transmitter/receiver of the 31 of the glasses 12 according to well known pairing techniques that are used to establish secure wireless connections between Bluetooth devices.

At step S10.6, the processor 39 of the phone 32 determines whether the phone 32 has been authenticated to command operation of the lock 2, for example by the Bluetooth pairing as just described, or using additional authentication in an initial set up procedure requiring additional authentication and/or encryption initialisation. If it is determined that the phone 32 is authorised to command operation of the lock 2, a command is sent from the phone 32 over the Bluetooth link established with the car lock 2 to open the lock as shown at step S10.8. If however the the phone 32 is found at step S10.6 not to be authenticated to operate the lock 2, an error message is displayed on the phone's user interface 42 as shown at step S10.7.

It will be appreciated that a similar process can be used to lock the car door. The phone 32 may provide enhanced encryption and other security controls for the transmissions to the tag 7 to ensure that only authorised persons may operate the lock 2 via the intermediary of the phone 32.

Many modifications and variations of the described systems are possible. For example, the lenses 10, 11 of the glasses 5 may form part of augmented reality (AR) display and, referring to FIG. 3, an AR source 43 may be provided to project visibly discernable data onto the lenses 10, 11 through a display configuration 44, so as to provide data to the user which may be associated with their current field of view. For example, with the control of the printer described with reference to FIG. 7, the AR display may provide start and stop buttons on the lenses 10, 11 of the glasses 12 so that once the printer has been started as described at step S7.3, the printer may be stopped by gazing at the stop button displayed on the lenses 10, 11. This avoids the user having to gaze continuously at the printer during printing.

Also, the detection of the AoA/AoD signals from respective device tags need not necessarily be performed at the glasses which comprise the controller 5 but could be carried out at different location, for example at the mobile phone 32. In some embodiments, the antenna array 19 may be provided at the mobile phone 32 along with the processing circuitry 26, 27, 28, although in one embodiment, the antenna array is provided on the glasses as shown in FIG. 2 and data received by the antenna array are transmitted by a wireless link to the mobile phone 32 for processing in order to obtain the orientation angle θ. Similarly, data from the retina detectors 17, 18 may be transmitted wirelessly to a remote location for processing, such as at the mobile phone 32.

In another embodiment, the remote device such as phone 32 provides command signals to the controller 5, for example to control the AR source and display 44. For example in the process shown in FIG. 10, the error message developed at step S10.7 can be transmitted back from the phone 32 to the glasses 12 for display on the lenses 10, 11.

Also, in the described examples, the detected predetermined relationship between the orientation angle θ and the gaze angle α occurs when they are in alignment. However, this need not mean exact alignment the predetermined relationship may include a range of angles around an exact alignment, suitable for indicating that the user is both oriented and gazing in generally the same direction. Also, the system may be configured to determine when a selected misalignment of the orientation angle θ and the gaze angle α occurs.

In the foregoing, it will be understood that the processors 30, 35, 39 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The or each processing circuitry or processor may be termed processing means.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Reference to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

It should be realised that the foregoing embodiments are not to be construed as limiting and that other variations and modifications will be evident to those skilled in the art. Moreover, the disclosure of the present application should be understood to include any novel features or any novel combination of features either explicitly or implicitly disclosed herein or in any generalisation thereof and during prosecution of the present application or of any application derived therefrom, new claims may be formulated to cover any such features and/or combination of such features.

1-27. (canceled)

28. A method comprising:
determining a direction of gaze of a user;
determining an orientation of a first device with respect to a second device based on at least one radio frequency packet passed wirelessly between the first and second devices using an array of antennas forming part of at least one of the devices;
determining whether the direction of gaze and the orientation of the first device with respect to the second device adopt a predetermined relationship, for controlling performance of a given operation, and
transmitting control signals for the first device in response to determining that the direction of gaze and the orientation of the first device with respect to the second device have adopted said predetermined relationship.

29. The method of claim 28 wherein the given operation comprises an operation of the first device, and comprises sending control signals for controlling the first device for performance of the given operation upon determination that the direction of gaze and the orientation of the first device with respect to the second device have adopted the predetermined relationship.

30. The method of claim 28, wherein the second device performing the determining whether the direction of gaze and the orientation of the first device with respect to the second device adopt a predetermined relationship.

31. The method of claim 28, further comprising using a gaze direction detector to determine the direction of gaze of a user.

32. The method of claim 31, further comprising using the gaze direction detector in the second device.

33. The method of claim 28, further comprising detecting retina movement of a user with eye tracking glasses to determine the gaze direction.

34. The method of claim 28, further comprising using an orientation detector located in the second device to determine the orientation of the first device with respect to the second device.

35. The method of claim 28, further comprising detecting a predetermined gesture made by a user, for causing control signals to be transmitted for the first device.

36. The method of claim 28, wherein the second device includes said array of antennas to receive at least one radio frequency packet passed wirelessly thereto from the first device, and the method further comprising comparing signals received by the antennas of the array in response to said at least one radio frequency packet to determine the orientation of the first device with respect to the second device.

37. The method of claim 28, wherein the determining whether the direction of gaze and the orientation of the first device with respect to the second device adopt a predetermined relationship, comprises determining whether the direction of gaze and the orientation of the first device with respect to the second device are in alignment.

38. At least one non-transitory computer readable memory medium having computer readable code stored therein, the computer readable code configured to cause a processor to:
determine a direction of gaze of a user;
determine, based on at least one radio frequency packet passed wirelessly between first and second devices using an array of antennas forming part of one of the devices, an orientation of the first device with respect to the second device;
determine whether the direction of gaze and the orientation of the first device with respect to the second device adopt a predetermined relationship, for controlling performance of a given operation; and
cause a transmitter coupled to the processor to transmit control signals for use in controlling the first device in response to determination that the direction of gaze and the orientation of the first device with respect to the second device have adopted said predetermined relationship.

39. The at least one non-transitory computer readable memory medium of claim 38, wherein determination whether the direction of gaze and the orientation of the first device with respect to the second device adopt a predetermined relationship, comprises causing the processor to determine whether the direction of gaze and the orientation of the first device with respect to the second device are in alignment.

40. An apparatus, the apparatus having at least one processor and at least one memory having computer-readable code stored thereon which when executed controls the at least one processor to:
receive gaze direction signals corresponding to a direction of gaze of a user from a gaze direction detector and orientation signals from an orientation detector operable to determine, based on at least one radio frequency packet passed wirelessly between first and second devices using an array of antennas forming part of one of the devices, an orientation of the first device with respect to the second device; and
determine, in response to receiving the gaze direction signals and the orientation signals, whether the direction of gaze and the orientation of the first device with respect to the second device determined by the orientation detector adopt a predetermined relationship, for controlling performance of a given operation,
detect, responsive to at least one of the gaze direction signals and the orientation signals, a predetermined gesture made by a user, for causing a transmitter to transmit control signals for the first device.

41. The apparatus of claim 40, wherein the processor is comprised in the second device.

42. The apparatus of claim 40, wherein the gaze direction detector is included in the second device.

43. The apparatus of claim 40, wherein the second device comprises eye tracking glasses including a detector for detecting retina movement.

44. The apparatus of claim 40, wherein the orientation detector is located in the second device.

45. The apparatus of claim 40, wherein the second device includes said array of antennas to receive at least one radio frequency packet passed wirelessly thereto from the first device, and a comparator to compare signals received by the antennas of the array in response to said at least one radio frequency packet to determine the orientation of the first device with respect to the second device.

46. The apparatus of claim 40, wherein determine the predetermined relationship comprises determine whether the direction of gaze and the orientation of the first device with respect to the second device, are in alignment.
